(19) United States
(12) Patent Application Publication
(10) Pub. No.: US 2017/0220985 A1
(43) Pub. Date: Aug. 3, 2017

(54) WIRELESS MONITORING SYSTEM

(71) Applicant: COLD CHAIN PARTNERS PTY LTD, South Melbourne, Victoria (AU)

(72) Inventors: Michael WHITE, Lima South, Victoria (AU); Kartheek Munigoti Shankar RAO, Tarneit, Victoria (AU)

(73) Assignee: COLD CHAIN PARTNERS PTY LTD, South Melbourne, Victoria (AU)

(21) Appl. No.: 15/328,752

(22) PCT Filed: Aug. 5, 2015
(86) PCT No.: PCT/AU2015/000466

§ 371 Date: Jan. 24, 2017

(30) Foreign Application Priority Data
Aug. 6, 2014 (AU) 2014903040

(51) Int. Cl. G06Q 10/08; H04Q 9/00

(52) U.S. Cl. CPC G06Q 10/087; H04Q 9/00; G06Q 10/0832; H04Q 2209/40

(57) ABSTRACT

A system which creates a wireless monitoring network of programmed and computing devices for the capture and transmission of real-time monitoring data. The system uses programmed devices that incorporate at least one sensor, a micro-controller, a data store, transmitters and receivers for multiple wireless communication methods and data input and output ports. The micro-controller may be programmed to operate the programmed device as a collector and transmitter of data from sensors in the programmed device or from other sensors connected to its input port, or as a reader and transmitter of data from other programmed devices. When a computing device is connected to a programmed device via USB, WiFi or Bluetooth (LE), the programmed device acts as a data reader providing monitoring data to the computing device. The system optimizes communications and power usage to maximize network sustainability and performance by managing alternative functional states with finite state machine firmware.

This invention relates to wireless monitoring systems and in particular the management of perishable goods in a supply chain including monitoring the environment of goods in transit and storage to manage the delivery and sale of goods before the expiry of the predicted shelf life.

### BACKGROUND TO THE INVENTION

The need for monitoring and interpretation of product and environmental conditions has burgeoned in recent years as consumers and regulators continue to demand ever-increasing quality, reliability and safety of products. This applies to a multitude of diverse products and services from food to pharmaceutical supplies and from evaporative cooling to computing systems.

The quality and safety of perishable food products can be significantly impacted by adverse environmental conditions. In fact their quality, longevity (shelf-life) and safety is substantially influenced by the temperature at which they are held at all points along the supply chain from production to consumption. Real-time knowledge of product and environmental temperatures is critical to effective management of perishable food supply chains.

The world produces around four billion tonnes of food for human consumption annually, and according to the FAO, 1.3 billion tonnes of food is lost or wasted each year. More recently, research by the Institute of Mechanical Engineers determined that 1.2 to 2.0 billion tonnes is wasted. As the world's population continues to increase (estimated to reach 9.5 billion by 2075) and our finite resources approach their limits, wastage and inefficiencies in the food system must be addressed.

Food wastage has severe negative environmental impacts because of the loss of energy, biodiversity, green-house gases, water, soil and other resources embedded in the food that no one consumes. The higher the level of processing and the later in the food chain that the wastage occurs, the greater these impacts are. Studies indicate that globally over 260 million tonnes of food is lost due to temperature abuse. In the US, this is estimated to cost $50 billion annually. With the demand and supply of fresh perishable foods increasing, the volume of food wastage, the requirement for energy to operate refrigeration systems and the risk of compromised food safety is also increasing. The US Centres for Disease Control and Prevention estimates that 48 million Americans suffer food illness every year and 5,700 people die. This costs the US economy $152 billion annually.

In most developed countries, Governments are tightening regulations to ensure compliance with food safety standards to reduce food safety risk. Regulations typically incorporate stringent requirements for monitoring and managing environmental parameters that impact on the quality and safety of specific foods. Regulations may also require Operators involved in the handling of perishable food to develop and implement Food Safety Plans. A key requirement of any Food Safety Plan is the regular and continuous monitoring and recording of food temperatures and the temperatures of the environments in which the food is held. Whilst a variety of monitoring systems are commercially available, the level of adoption by the food industry remains low, primarily due to the high infrastructure cost of these systems. This is particularly so across small to medium sized food operators who continue to rely on manual processes to fulfil their regulatory obligations.

Manual monitoring processes have many points of failure and provide limited opportunities for pro-active management. Temperature records are often missed or incorrectly logged, and there are no alerts or notifications when temperatures breach tolerances. Manual monitoring provides no insight regarding business critical information such as the cumulative effect of temperature over time; a major determinant of the remaining shelf-life and safety of a food product. Nor does it assist in improving business efficiencies that result from better management of climate-controlled assets such as cool stores, freezers, merchandising cabinets etc. Most monitoring solutions aim to improve supply chain management through the use of small wired or wireless sensor devices which capture and transmit sensor data directly to a reader or gateway. If the sensor device cannot transmit data directly, repeaters are typically deployed. Gateways are usually connected to an existing network or they may incorporate their own connection to transmit data to either a local or cloud-based information system. Since most sectors within the food industry consider this approach to be expensive and complex, adoption rates are low. The vast majority of small and medium sized business in the food industry will only displace manual monitoring with an automated solution if the cost of doing so is not a barrier and the return on investment is perceived to be high.

USA patent application 2004/0226392 discloses a monitoring system including a monitor with multiple sensors and a processor for transforming the sensor signals into data and a transmitter for periodically sending the data to a computer or handheld device. The data is then available for analysis and report generation. WO2006/110092 discloses a food sensor system using optical sensors wirelessly sending data to a computer or handheld device for processing the sensed data. Chinese application 100595538 discloses a wireless temperature sensor fitted to a cargo box that is able to be read by a reader installed at a warehouse entrance. USA patent application 2008/0294488 discloses a transport system to input transport and storage parameters to report the occurrence of parameters outside a specified range. USA patent 8447703 discloses a cool chain system that allows for replacement of stock following the discovery of a quality abnormality during transport or storage.

Chinese patent application 103679370 discloses fresh agricultural product shelf life management software which has a shelf-life calculation module but no explanation of what that entails.

It is an object of this invention to provide a low-cost means of automatically capturing, communicating and interpreting sensor data so as to provide better information and tools to assist in the management of food supply chains.

### BRIEF DESCRIPTION OF THE INVENTION

To this end the invention provides a product and environment condition monitoring system which is comprised of three parts, including a Smart Tag, a mobile information system and a cloud-based information system. The mobile information system (herein called “Mobile App”) is a suite of mobile modules including login, dashboard, configuration management and updater services which runs on a Smart Device. The cloud-based information system (herein called the “Cloud App”) is a suite modules including login, dashboard, configuration management, updater services and business intelligence services. The Cloud App is a far more comprehensive system compared to the Mobile App, since it stores the data from all Smart Tags and supports a more sophisticated suite of services.

The wireless monitoring system of this invention may be applied within any industry where temperature, humidity, shock or any other environmental condition may affect quality, safety or performance. Such industries include but are not limited to agriculture, fishing, health, pharmaceutical, mining, computing, telecommunications and manufacturing. For the purposes of describing this invention, applications for the perishable food industry are referenced and described.

In one aspect the invention is based on a programmed device that includes at least one sensor, a processor, a data store, a transmitter and receiver for wireless communication and, wherein the processor is programmed to operate the device as a data collector for data signals from the sensor in the device or from other sensors wirelessly connected to the device and when a computing device is wirelessly connected to the programmed device it acts as a data reader providing data to the external computing device.

The programmed device may additionally include at least one data input port to enable connection to other sensors or other programmed devices and/or at least one output port and when a computing device is connected to said outlet port it acts as a data reader providing data to said external computing device.

Maximising the collective business objectives of extending product shelf-life (to reduce waste and food safety risk), compliance with food safety regulations and improving refrigeration efficiency (to reduce energy consumption and greenhouse gas emissions) can be most effectively achieved through deployment of a disruptive technology in the form of a single smart monitoring device which is multi-functional and auto-configurable and dramatically reduces the current cost of automated wireless monitoring.

This invention has overcome the need for expensive gateways and repeaters, requiring only a single smart device and existing user devices such as smart phones, tablets, telematics devices, modems, and other wireless hot spots (herein called “Smart Devices”) to create and manage a connected network and to deliver data to both local and cloud-based information systems where monitoring information is interpreted and displayed.

The foundation of this invention is a single Smart Tag which incorporates multiple sensors (such as temperature, shock, discrete, proximity), a micro-controller, RAM and flash memory for data storage, an RF/BLE/WiFi transceivers for wireless communications, input/output ports and converters to support the connection of other sensors and devices. The micro-controller incorporates a Finite State Machine (“FSM”) and associated firmware which automatically monitors, analyses and controls (auto-configures) the functional state of a tag. This process is herein called smart state management (“SSM”). In one embodiment of the invention where multiple input and output ports are integrated into the tag, any analogue or Resistance Temperature Detector (RTD) sensor may be connected, including but not limited to sensors which measure temperature, humidity, shock, discrete events, gas concentrations, fluid levels, conductivity, dissolved oxygen or any other measurable environmental condition.

A Smart Tag in accordance with this invention may be a “Sensor Tag” whereby it is configured to function in sensor-mode to collect monitoring data (from internal or external sensors), interpret, store and then transmit this data to other Smart Tags or Smart Devices, or it may be a “Reader Tag” whereby it is configured to function in reader-mode to receive and acknowledge monitoring data from Sensor Tags, interpret, store and then transmit this data to Smart Devices via one of three alternative communication methods including USB cable, BLE or WiFi. RF is an additional method of communication which is used between Smart Tags since it provides an enhanced communication range and power efficiency compared to the other methods.

Whilst three communication methods are available, communication between Smart Tags is preferably via RF due to range and power efficiencies. To optimise RF communications within a network, Sensor Tags can be configured as transceivers (rather than transmitters) so they may receive data from other Sensor Tags and re-transmit this data to other Smart Tags in either ‘sensor’ or ‘reader’ mode. This creates a ‘mesh’ network topology which overcomes the signal strength limitations imposed by standard ‘star’ networks. This is one aspect of SSM, whereby the FSM controls the communication state and the network topology by monitoring tag inputs (called physical or hard interrupts) and wireless communications (called software interrupts). In ‘reader’ mode the tag's FSM can auto-configure the communication state of other ‘sensor’ tags within a network.

The current state of a Smart Tag is continuously monitored and evaluated by its FSM other associated firmware embedded in the tag, and if sub-optimal, it is automatically re-configured to an alternative state which may include communication via an alternative method. In certain states, the FSM of one tag may also control the states of one or many other tags in a network. For example, to optimise RF communications within a network, Sensor Tags can be configured to function as data transceivers (rather than just as data transmitters) so they may receive data from other Sensor Tags and re-transmit this data to other Smart Tags in either sensor or reader mode. This creates a ‘mesh’ network topology which overcomes the signal strength limitations imposed by standard ‘star’ networks. This is one aspect of SSM, whereby the FSM controls the communication state and the network topology by monitoring tag inputs. These inputs may include physical or hard interrupts (such as the physical connection of a PC via the USB port) and wireless or software interrupts (such as the wireless connection of a Smart Device via BLE). The FSM in a Reader Tag may automatically configure the communication state of one or many Sensor Tags that may be collectively capturing and reporting data. This capability enables all tags within a “monitoring network” (a collection of one or more Sensor Tags and one or more Reader Tags within a defined environment such as a warehouse facility or grocery store) to function optimally in terms of location, directional positioning, power consumption and communication. This is achieved without human intervention.

If performance in the current state is determined to be sub-optimal, the FSM automatically re-configures the Smart Tag and/or other Smart Tags to communicate via an alternative method. The change of state of a Smart Tag may also be triggered by an event or ‘interrupt’ such as the physical connection of a PC (via USB) or wireless connection of a Smart Device (via BLE).

Smart Tags may create and automatically manage a wireless network (which may include one or many hundreds of tags) to communicate monitoring data within a defined area (such as a warehouse facility or grocery store). When a Sensor Tag prepares to transmit monitoring data it interprets and formats (constructs) the data into a message or packet structure called a “Data Packet”. Smart Tags can communicate via one of four alternative communication modes namely RF, BLE, WiFi or USB. RF is the preferred communication method between Smart Tags, whilst Smart Devices may connect to a network via USB, BLE or WiFi. The inclusion of Smart Devices running the Mobile App within a network (whether connected continuously or intermittently) is crucial to the invention and makes expensive gateways and repeaters redundant.

Preferably the automated Monitoring Network of this invention incorporates small inexpensive ‘plug and play’ wireless devices (herein called ‘tags’) that detect, store, manage and transmit environmental data (including but not limited to, temperature, humidity, shock, power consumption, and security data, herein called ‘data’). Tags in ‘sensor’ mode may transmit data via 2.4 GHz Radio Frequency (RF) band to another tag in ‘reader’ mode that is connected to a third party device (such as a laptop, point of sale system, telematics device, PC or similar communication device, herein called a ‘User Device’), or directly to a User Device (such as smart phone, tablet) via Low Energy (LE) Bluetooth.

The System includes User Device Software (UDS) which operates on a User Device to enable receiving, storing, interpreting, displaying and transmitting data. System Users can access transmitted data locally on a User Device through enabling UDS applications. Data may be further transmitted from a User Device to the Cloud-based Data Management Service via the User Device Internet connection leveraging the existing internet connectivity.

The System includes a Mobile App which operates on a Smart Device. This enables the Smart Device to communicate with Smart Tags via BLE or WiFi and to receive, store, interpret, re-transmit and display data. The Mobile App provides a dashboard to view current data (e.g. temperature, door status and battery condition) and a service for configuring Smart Tags and uploading new firmware. The Mobile App enables the transmission of captured data from the Smart Device to the Cloud App manually or automatically when the Smart Device is connected to the Internet, thereby leveraging existing internet connectivity.

User access to monitoring information on the Mobile App is managed by a Login Service which includes secure logins and software security keys. This service exposes the UI which incorporates a Dashboard (an intuitive display of monitoring information in the form of tables, graphs and other presentations), Administrative Services (which provides support and help desk) and the Configuration Manager (where tag, alert, and user functionality can be configured). The Mobile App provides Internet connectivity to enable monitoring data to pass to the Cloud App. In a wireless monitoring application, Sensor Tags act similarly to nodes in a network. In one configuration Smart Tags may function as RF transmitters and in another configuration they may function as RF transceivers. When Sensor Tags function as RF transmitters they transmit data with the expectation of this data being received by a Reader Tag which always functions as an RF transceiver. In this arrangement the network is described as having a ‘star’ topology. When Sensor Tags function as RF transceivers they may receive data from other Sensor Tags and re-transmit this data with the expectation of data being received by other Sensor Tags or Reader Tags. This extends network coverage and is described as a ‘mesh’ topology. In this invention, the RF network may be a hybrid of these topologies, with selected Sensor Tags in RF transmitter mode and others in RF transceiver mode. Moreover, the topology of individual tags may be switched according to the communication performance which is constantly monitored and managed by the network itself. This is an important capability since it is always preferable for a Sensor Tag to function solely as an RF transmitter due to the additional battery power consumption associated with ‘listening’ whilst in RF transceiver mode.

When a Smart Device is connected to the Internet, any captured tag data is automatically forwarded to the Cloud App Listener which processes the decrypted tag data and places it into specific tables within the Cloud App Database. The Listener may also provide specific tags with the latest tag firmware or configurations through the Updater Service. The Packet Processor is responsible for interpreting Tag Data and converting it into usable information which can be displayed through the User Interface.

The Cloud App incorporates many different services. For example it incorporates a Web Service which is a point of integration for inward and outward data flows between the Cloud App and other systems. Data from sources other than Smart Tags may also be received through the Web Service. The Notification Service generates messages (Push Notifications, SMS and email) based on alerts and other events and the Shelf-life Service feeds data into shelf-life models to estimate the remaining days before expiry of a product. These application services analyse data based on rules, algorithms and models to create valuable business intelligence. The primary aim of generating business intelligence in the invention is to provide Users with a foundation of empirical information upon which ‘change management’ may be applied to improve business performance. In a similar way to the Mobile App, user access to monitoring information is managed by a Login Service which includes secure logins and software security keys. This service exposes the User Interface which incorporates a Dashboard (an intuitive display of monitoring information in the form of tables, graphs and other presentations), Administrative Services (which provides support and help desk) and the Configuration Manager (where the functionality of tags, alerts, users, reports and all other aspects of the system can be configured).

The Cloud-based Data Management Service receives, stores and manages data. This data is interpreted and enriched by Intelligent Monitoring Applications that provide ‘dashboard’ interpretations of real-time and historical data, as well as reports and notifications. The applications support:
energy efficiency determination (for temperature-controlled environments based on real-time product temperature, ambient temperature and energy consumption),
real-time remaining ‘shelf-life’ determination (based on the starting quality characteristics of a product and real-time correlated temperatures during shipment),
a change management service to effect performance improvements for the System User, and
a business rules alerting system catering to the individual client requirements.

The Service may also transmit defined sets of data via secure web services for integration with other User and Third Party Systems. User access to the Intelligent Information Service is preferably managed by secure logins and software security keys. All data may be transmitted using the industry encryption standards to prevent any data theft.

This system generates monitoring information which can be used to assist the distribution and sale of perishable goods based on their remaining shelf-life.

To this end the present invention provides method for managing the distribution and sale of perishable goods in which data relating to the condition of the goods is entered and stored at the time of dispatch of said goods; data relating to the environment of said goods during transport and storage is regularly collected and stored and periodically transmitted to a central processor; the predicted shelf life of said goods is calculated by said central processor programmed to use the dispatch data and the transport and storage data to calculate an expected expiry date; and an expected expiry date for the goods is assigned to said goods at the time when the goods are displayed for sale.

This invention provides a system for managing the distribution and sale of products in which data relating to the starting quality characteristics of products is scored and entered into the system prior to shipment. During shipment, real-time temperature data is captured and reported by Smart Tags configured in shipment-mode to function under transit rather than storage conditions (herein called “Shipment Tags”). Based on the initial starting quality data and subsequent temperature readings, the remaining shelf-life of the product (in days) is calculated by a shelf-life model and made available to the User. This information may also be used to assist Users to apply a FEFO distribution methodology.

Data relating to the condition of the goods is entered and stored at the time of dispatch of said goods; data relating to the environment of said goods during transport and storage is regularly collected and stored; the predicted shelf life of said goods is calculated using the dispatch data and the transport and storage data and an expected expiry date for the goods is assigned to said goods at the when the goods are displayed for sale.

Real-time Shelf-life determination is a key Intelligent Monitoring Service supported by the System. It provides an estimate of the remaining shelf-life of a monitored product in real-time.

### DETAILED DESCRIPTION OF THE INVENTION

A preferred embodiment of the invention will now be described with reference to the drawings in which:

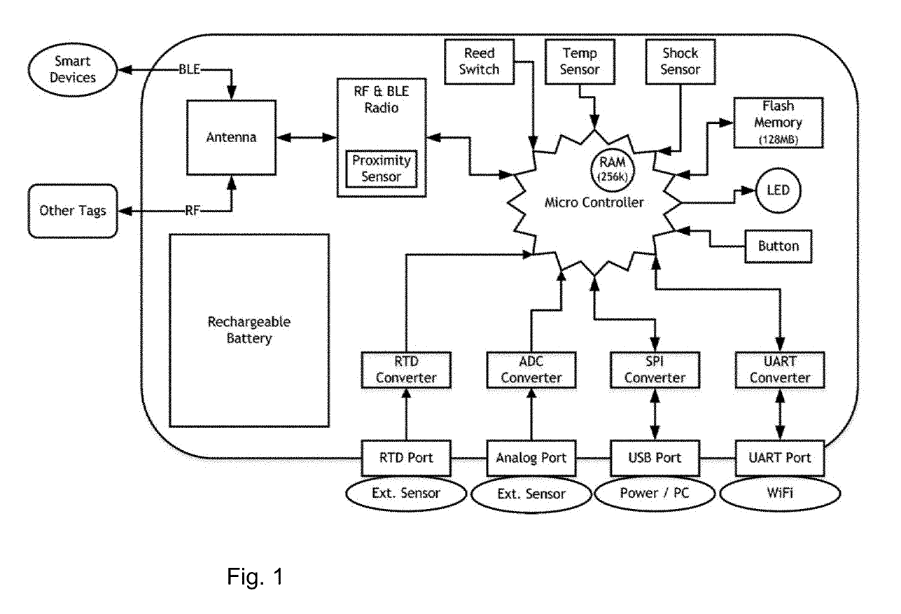

FIG. 1 is a diagram of the primary hardware components of the Smart Tag embodiment of this invention;

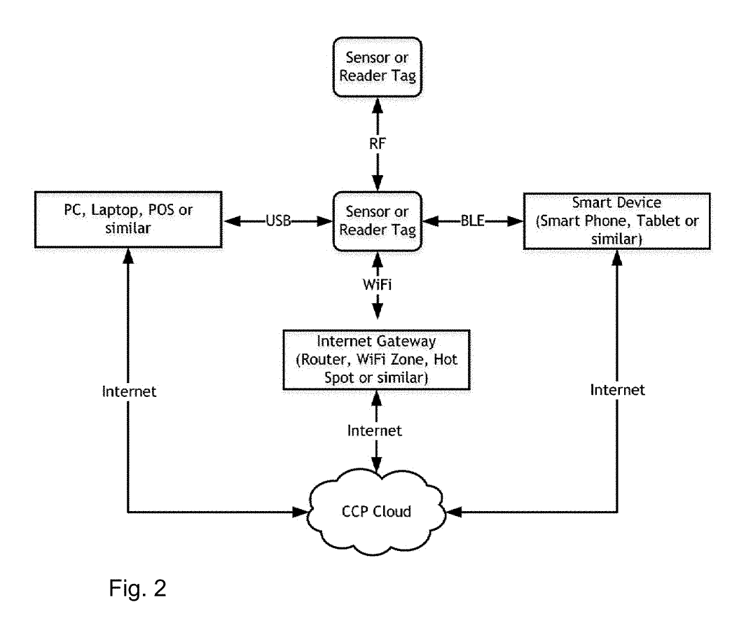

FIG. 2 is a diagram of the four alternative methods of communication deployed by the Smart Tag embodiment of this invention;

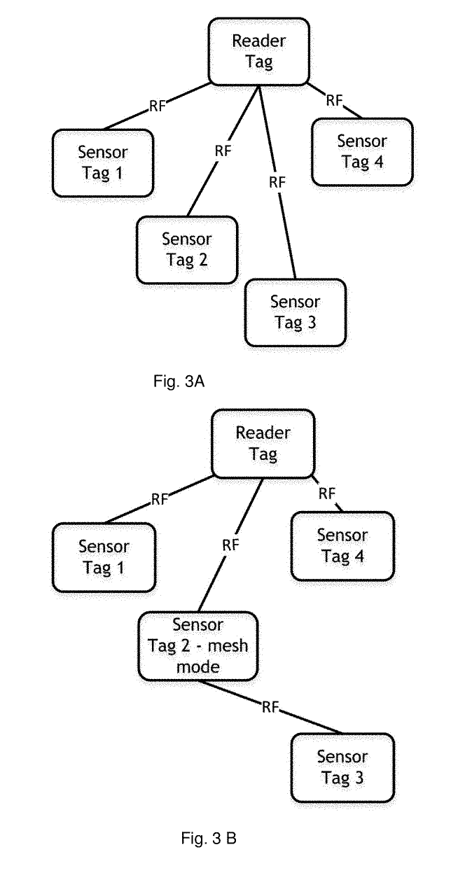

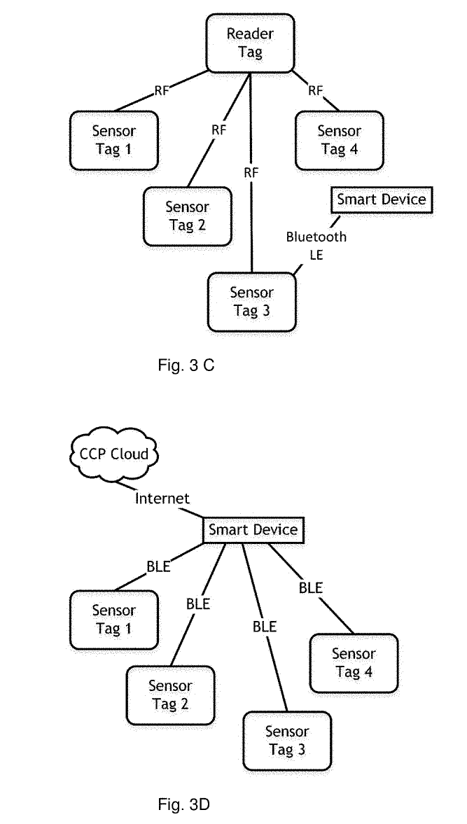

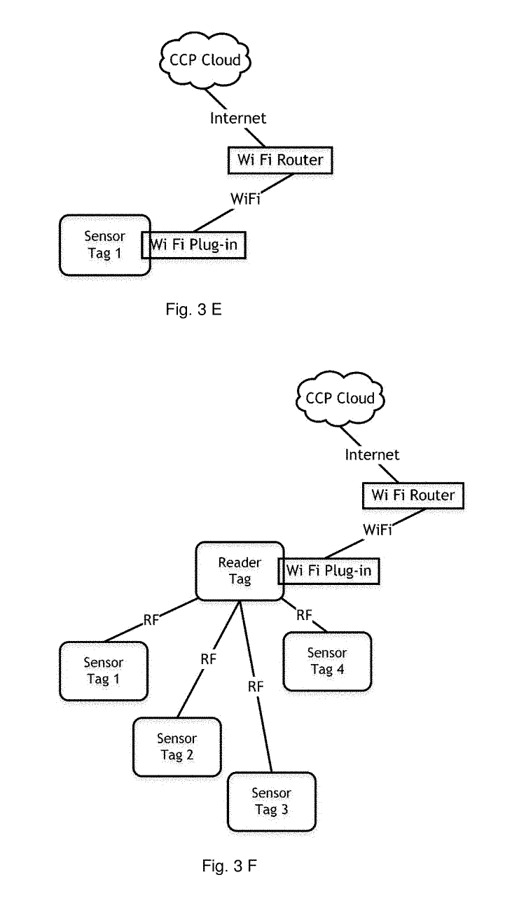

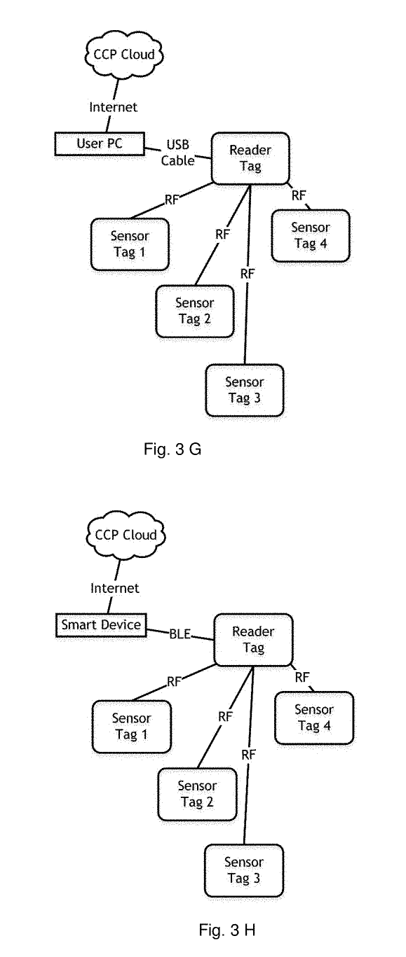

FIG. 3 depicts each of the major states in which a tag may be configured including:

FIG. 3a depicts tags in the Sensor (RF Star) Mode

FIG. 3b depicts tags in the Sensor (RF Mesh) Mode

FIG. 3c depicts tags in the Sensor (Transitional BLE) Mode

FIG. 3d depicts tags in the Sensor (Static BLE) Mode

FIG. 3e depicts tags in the Sensor (WiFi) Mode

FIG. 3f depicts tags in the Reader (WiFi) Mode

FIG. 3g depicts tags in the Reader (USB) Mode

FIG. 3h depicts tags in the Reader (BLE) Mode

FIG. 3i depicts tags in the Shipment Mode

FIG. 3j depicts tags in the Shipment (RF Mesh) Mode

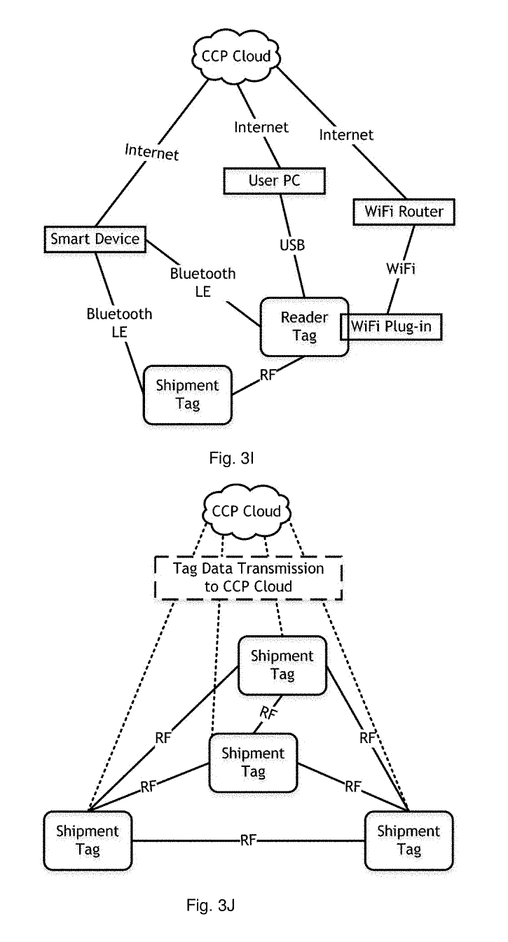

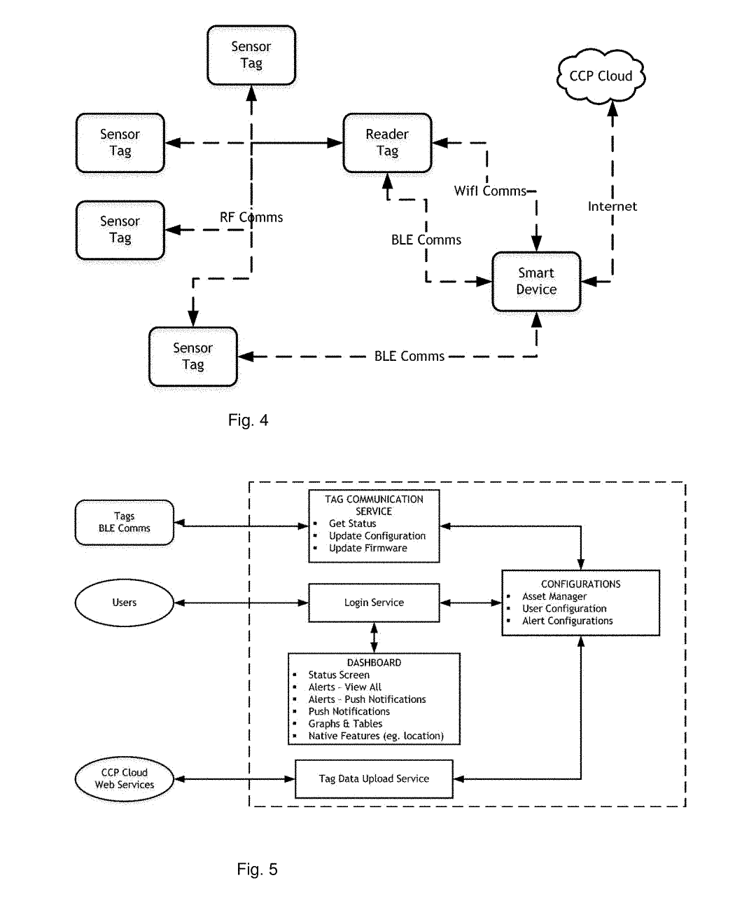

FIG. 4 is an overview of the In Store Monitoring application of the invention;

FIG. 5 is an overview of the Mobile App System embodiment of this invention;

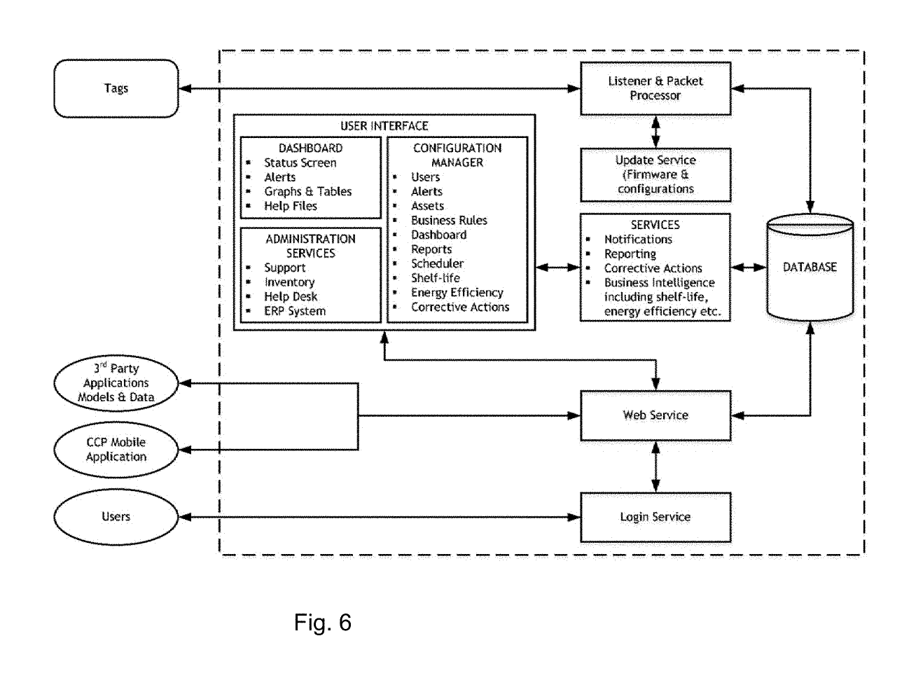

FIG. 6 is an overview of the Cloud App System embodiment of this invention;

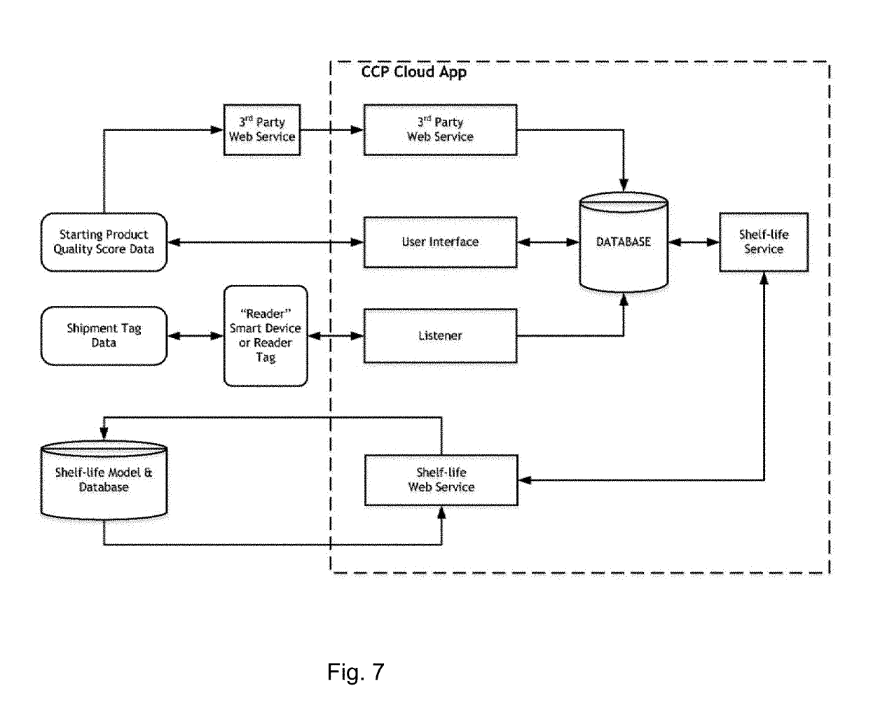

FIG. 7 is an overview of the Shelf-life Service embodiment of this invention;

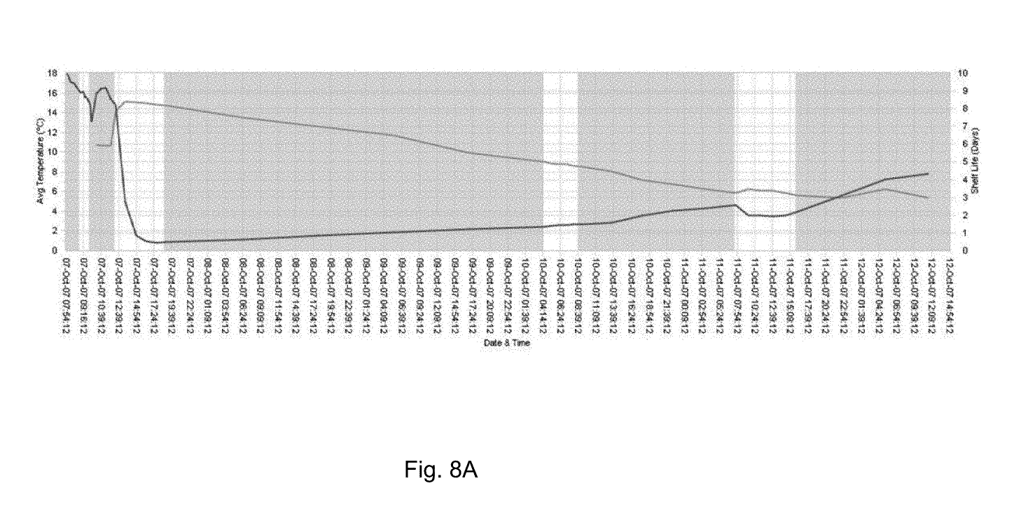

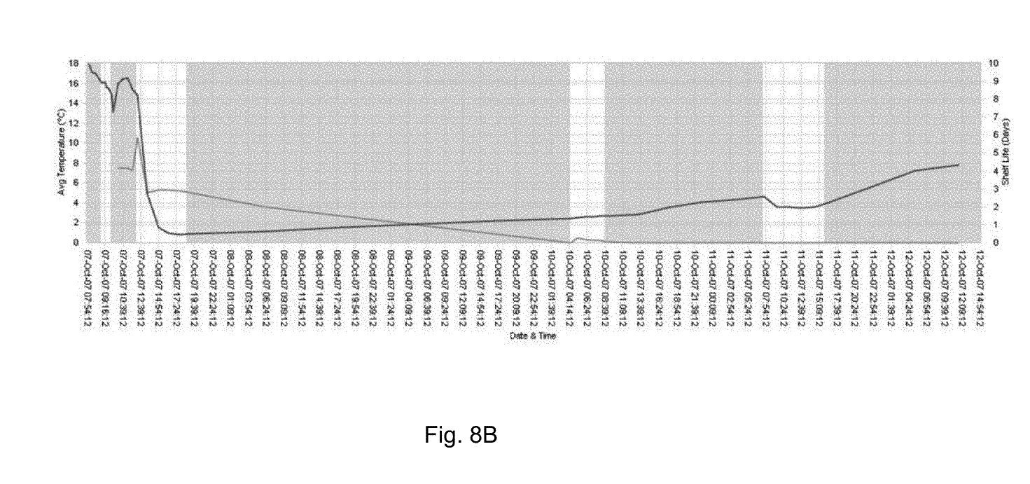

FIG. 8a is a shelf-life curve for a shipment conducted under optimal temperature control conditions as generated by the Shelf-life Service embodiment of this invention;

FIG. 8b is a shelf-life curve for a shipment conducted under sub-optimal temperature control conditions as generated by the Shelf-life Service embodiment of this invention;

### SMART TAG HARDWARE

The Smart Tag, as shown in FIG. 1, is encased in a food-grade plastic moulded enclosure with an IP65 rating to protect the integrity of the tag electronics when located in high moisture environments, such as those typically experienced within a climate-controlled supply chain. It operates within the temperature range of −30° C. to +70° C. Since one intended use is in food retail applications where it is mounted within climate-controlled display cabinets, the tag is aesthetically designed and accommodates various mounting options for fixing or hanging. It is also small in size so as to be versatile in its application, highly visible and robust in its construction.

The main electronic components of the Smart Tag include:
1. Micro-controller incorporating RAM (256K) and 2.4 GHz RF/BLE transceiver radio (with proximity sensor) herein called the “MC Radio”
2. Flash memory for data storage (128 MB)
3. 2.4 GHz WiFi transceiver radio herein called the “WiFi radio”
4. Real Time Clock herein called the “RTC”
5. Antenna
6. Internal sensors (temperature, shock, contact)
7. Input/output ports and converters (for connection of other sensors and devices)
8. Button (for configurations)
9. LED (tri-colour)
10. Battery (rechargeable lithium polymer type)

The Micro-controller provides the processing power to interpret and manage the functionality and operation of the tag. Smart Tag firmware, which runs on the Micro-controller, incorporates a Finite State Machine (“FSM”) and associated applications to automatically monitor, analyse and control (auto-configure) the functional state of the tag, and in some instances, that of other tags. This process is called smart state management (“SSM”). The RAM component of the Micro-controller includes the soft device, application and boot loader.

Flash memory is used to store data which could include up to 30,000 data points or other cold chain information relevant to the product being monitored. This data is never lost regardless of the replaceable battery condition. In addition to data, the flash memory stores all the configurations and a copy of the firmware.

Radio modules may be deployed in various ways. They may be integrated with the Micro-controller, separately located on the Printed Circuit Board (“PCB”), or plugged into the Smart Tag via Port 1. However they are integrated, the radios operate within the 2.4 GHz to 2.5 GHz frequency band and provide three wireless methods for the transmission and receipt of data. When they are active (i.e. either ‘listening’ or transmitting) they consume more battery power than any other component. This is particularly so for BLE communications, which has the added disadvantage of shorter communication range compared to RF. Therefore, by default, a Smart Tag will use RF for communications with other tags in a network. When a Smart Device connection becomes available, tag firmware auto-configures communications to BLE mode. This is closely monitored by the FSM to ensure that BLE communications are minimised in order to reduce battery power consumption. One communication configuration involves cycling between RF and BLE modes, whilst another involves alternating between transmitter and transceiver modes. The many alternative functional states of the Smart Tag are described in detail (see Smart Tag Functionality).

Smart Tags have a Real Time Clock (“RTC”) which provides many advantages over alternative time keeping approaches. Tag firmware preferably ensures that the RTC is regularly updated and thereby synchronised across all tags within a network. This enables tag transmissions to be precisely managed (to overcome RF collisions) and for accurate records of the time of data capture and transmission for each tag to be maintained. It also enables a tag which is not expected to be in range of a reader or Smart Device for a lengthy period to be configured to commence transmission at a future time. By so doing, battery power consumption can be minimised.

The antenna is preferably designed in an “F” shape on the printed circuit board (PCB) to maximise the useful range of the transceiver whilst minimising necessary space. Precise antenna tuning provides an RF range in excess of 220 metres in clear air. Whilst the range is reduced in typical installations such as cool stores or retail store applications, the RF range still exceeds 100 meters in most situations. The Smart Tag incorporates a number of internal sensors which monitor the critical parameters for many applications. On board temperature is captured through temperature sensor which is accurate over the range of −30° C. to +80° C. The temperature sensor is electronically calibrated every time tag is turned on (and deploys continuous validation software) to ensure an accuracy of better than +1-0.5° C. Shock is monitored by a three-axis accelerometer over the range of 0 G to 16 G with a range in sensitivity from 256 LSB per G to 32 LSB per G (where LSB is least significant bit). A reed switch, which is activated by an external magnet, senses discrete events (such as a door opening or closing). The Micro-controller radio incorporates a proximity sensor which transmits a Radio Signal Strength Indication (RSSI). This is used to indicate the distance between the Sensor Tag and a Reader Tag or a Smart Device.

In one version, the Smart Tag includes four ports each with an associated converter to capture and interpret data from external sensors. Three of these ports are ‘audio-jack’ type connections and the other is a standard Mini USB connection. When an external module or sensor is connected to the Smart Tag, it is automatically recognised and configured to exchange data with that source.

Audio-jack connectors have been used in preference to other monitoring device connectors to overcome the problem of disconnections. The 3.5 mm audio-jack also has four contacts compared to three for most other monitoring device connectors.
Port 1 is a 3.5 mm audio-jack connector and a Universal Asynchronous Receiver Transmitter (UART) converter for WiFi Module
Port 2 is a USB connector and a Serial Peripheral Interface (SPI) converter for power input or PC connectivity via a USB cable
Port 3 is a 2.5 mm audio-jack connector and an Analogue to Digital Converter (ADC) for analogue sensor input
Port 4 is a 2.5 mm audio-jack connector and a Resistance Temperature Detector (RTD) converter for digital sensor input

A temperature probe may be connected to a Smart Tag (via Port 3) to provide remote sensing and/or to extend the monitoring range to −60° C. to +200° C. Monitoring hot environments, such as warming ovens and roller grills, is also an application of the invention. For the food industry, temperatures in the range of +5° C. and +60° C. fall within the Temperature Danger Zone. This is because bacteria can grow to unsafe levels between these temperatures. All cooked foods must be maintained at a temperature of greater than +60° C. and this should be monitored in same way as chilled or frozen foods. Smart Tags can accommodate any analogue or RTD sensor including, but not limited to sensors which measure temperature, humidity, shock, discrete events, gas concentrations, fluid levels, conductivity, dissolved oxygen or any other measurable environmental condition. These sensors may be connected to a Smart Tag via Ports 3 or 4. In another version of the Smart Tag there are no ports, thereby enabling a higher IP rating.

The Smart Tag button provides the User with a means of physically re-configuring or changing the state of the tag. For example, by depressing the button in a defined way, the tag may be turned ON or turned OFF. It may also be configured into BLE transceiver mode or into firmware update mode.

The tri-colour LED (red, green and yellow) provides the User with a clear indication of the tag's state when the button is used. The LED may also be configured to ‘flash’ when specified conditions occur, such as the temperature being detected outside defined upper or lower limits.

The internal battery is a rechargeable 3.7V lithium polymer type with a single charge life of 12 to 18 months under a standard configuration. Tag firmware controls the ability to recharge the battery through the USB port. Alternatively, single life coin cell batteries may be used in another version of the Smart Tag (which includes other modifications) to further reduce system cost.

### Smart Tag Communication Methods

A unique embodiment of this invention is the intelligent Smart Tag firmware which supports the automated management and configuration of a large number of alternative states of functionality. Many of these states of functionality are based on the deployment of different methods and modes of communication.

Smart Tags can communicate via a USB cable or via a wireless connection. Wireless communication is undertaken within the 2.4 GHz to 2.5 GHz radio frequency band, which is accessible world-wide for monitoring applications such as this invention. Within this frequency band, Smart Tags can communicate using any one of three methods. The choice of communication method is determined by the FSM and its associated firmware. The four methods of communication shown in FIG. 2 are described as follows.

### RF Communications

When turned ON, a Smart Tag is preferably configured as a Sensor Tag in RF Transmission Mode by default. As the most common and preferred functional state, RF transmission enables long range (greater than 200 meters in clear air) communications between Smart Tags. Since RF communication is high speed, it requires short connection times and is the most energy efficient means of communication within the frequency range. When a Sensor Tag or Reader Tag is configured in RF Transceiver Mode it can automatically send and receive communications (including Tag Data, configurations and firmware updates) using this efficient method. A Sensor Tag in RF Transceiver Mode is in ‘mesh’ network mode, allowing it to send and receive Tag Data.

### Bluetooth Low Energy Communications

When a Smart Tag is configured to communicate with a Smart Device (such as a smart phone or tablet) running the Mobile App, it does so using Bluetooth Low Energy (BLE). Whilst BLE uses significantly less energy compared to standard Bluetooth, it consumes more power and communicates over a shorter range compared to RF. However, if managed appropriately, BLE provides a convenient means of accessing real-time information from a Smart Tag, particularly when in Shipment mode.

### WiFi Communications

This invention provides for the integration of a WiFi engine on the Smart Tag PCB or alternatively the use of a WiFi Module as a plug-in. In either aspect of the invention, the capability of the Smart Tag to communicate via WiFi provides almost ubiquitous connectivity with Smart Devices and the Cloud App. WiFi communications have a moderately long range (up to 100 meters in clear air) and high power usage. In a standard application of the invention (as depicted in FIG. 3F), a Reader Tag will transmit Tag Data from one or many Sensor Tags in a network to the Cloud App using WiFi. By connecting power via the USB port, the Reader Tag may undertake continuous communications without concern for battery longevity. The use of a rechargeable battery enables continuous operation (monitoring) even if the external power source is compromised (i.e. when there is a power failure).

### USB Communications

A Smart Tag may be physically connected to a PC, Laptop or similar, via a standard USB cable. This connection supports communications to the Cloud App through the device's existing Internet connection and provides the tag with an external power supply. Consequently, in this configuration there is no requirement for careful management of power consumption. Connection of a USB cable triggers auto-configuration into a Reader Tag in RF Transceiver Mode, whereby the tag is always ‘listening’ for RF transmissions from Sensor Tags in the monitoring network.

### Data Packet Construction and Types

Monitoring data captured by a Sensor Tag is interpreted and formatted (constructed) into a message called a Data Packet. Efficient Data Packet assembly and transmission is critical to battery longevity. To ensure power consumption is kept to a minimum when transmitting, real-time data packets are kept to just a few bytes in size and short ‘burst’ transmission techniques taking just a few milliseconds are deployed. Data Packet construction and transmission rates are both user-configurable and self-configurable.

In the standard embodiment of this invention, a Sensor Tag prepares data for RF transmission by constructing either a Real-time Data Packet or a Batch Data Packet. A Real-time Data Packet contains the encrypted monitoring data relating to a single (monitoring) instance together with other standard information such as, but not limited to, the tag identifier, battery condition, data capture time and data transmission time. A Batch Data Packet includes the same data, but for multiple instances. To minimise packet size, Batch Data Packets have a different structure to Real-time Data Packets and are binary encoded to reduce packet size and increase security.

For In Store applications where Sensor Tags and Reader Tags are generally within RF range, most transmissions will involve Real-time Data Packets. If RF connectivity is lost, then the Sensor Tag will construct a Batch Data Packet for transmission when connectivity is resumed. When a Smart Tag is configured as a Shipment Tag for the purpose of continuous monitoring within a shipment, data is automatically transmitted in Batch Data Packets when the tag comes into range of a Reader Tag, Smart Device or any other appropriate receiver.

To ensure data security, all Data Packets are encrypted and can only be decrypted and accessed by a unique key which is managed to ensure high security of data and currency of service and subscription fees.

### Data Packet Acknowledgement

If a Reader Tag receives a Data Packet transmitted by a Sensor Tag, the Reader Tag transmits an acknowledgement (called an ‘ACK’) back to the Sensor Tag provided the Data Packet is in good order (i.e. that it has been properly constructed). When an ACK is received, the Data Packet is registered by the Sensor Tag as having been successfully transmitted. This process ensures the integrity of both the data and the RF network.

If an ACK is not received by a Sensor Tag immediately following a Data Packet transmission, it will re-transmit the Data Packet. The number of re-transmissions (“re-tries”) is configurable. The default setting aims to strike a balance between maximising the prospect for real-time communications whilst minimising battery power consumption. Once the ‘re-try” setting has been reached, the Sensor Tag is re-configured commence regular transmission of a Heart-beat Packet (which consumes minimal battery power) and to construct a Batch Data Packet. A response to the Heart-beat Packet triggers transmission of the Batch Data Packet which will include all of the stored data not previously acknowledged as having been received. When out of communication range, the Sensor Tag acts as a quasi ‘data logger’ which remains capable of transmitting its data as soon as RF communication with a Reader Tag is resumed. At least 30,000 data points may be stored on a Smart Tag.

When a Sensor Tag is paired (via BLE) with a Smart Device, the Mobile App on the Smart Device may transmit a request for current data (or a request to update the tag firmware or configuration). In response, the Sensor Tag will transmit its most current data without expectation of an acknowledgement or any change in its RF communication process. Whilst data may be stored on a Smart Device, the Mobile App treats this data as ‘view only’ data. This ensures that data storage is synchronised between Smart Tags and the Cloud App.

Finite State Machine (FSM) & Auto-Configuration

Smart Tags combine the deployment of a Finite State Machine (FSM) with substantial processing power and memory capacity to enable the auto-configuration of many alternative functional states without human intervention. Embedded in the tag firmware, the primary purpose of the FSM is to manage the functional state of a tag and a network in real-time so as to maximise performance of both. In this invention, optimal performance occurs when Smart Tags use minimal battery power to maximise the speed and reliably of data communications throughout the monitoring network, and as such function as part of the “Internet of Things”. This firmware approach involves Smart Tags continuously monitoring their own performance and that of other tags and devices within a monitoring network, and managing the functional state of the network through auto-configuration methodologies.

Plug & Play Capability

Smart Tags incorporate ‘plug & play’ capabilities which aim to minimise User work-load. Plug and play enables the discovery and deployment of hardware components (such as a WiFi module or an external probe) without the need for User configuration or any other human intervention. The FSM continuously monitors the state of each hardware connection (e.g. USB port) and each software connection (such as a wireless signal or data) and determines how the tag should function in response to a specific change of state. This determination may be based simply on a connection being made, or it may involve data analysis and modelling before an appropriate change of configuration or mode can be identified and implemented. For example, when turned ON a Smart Tag is configured in Sensor (RF Star) Mode by default. In this mode the tag is ready to capture data from its sensors, interpret, store and subsequently transmit a Data Packet via RF. However, when a WiFi module is connected to the tag, the FSM re-configures the tag in Reader (WiFi) Mode. The tag now functions as a transceiver receiving Data Packets from Sensor Tags via RF, interpreting, aggregating, storing and subsequently transmitting this data via a WiFi connection to the Cloud App. This change of functionality occurs without any human intervention beyond connecting the WiFi module to the tag. Furthermore, if a critical communication failure occurs, such as disconnection from the WiFi network, the FSM auto-configures the tag to transmit tag status messages via Bluetooth LE. A Smart Device running the Mobile App will receive these messages and will be alerted to the network failure. Once repaired, the FSM will auto-configure the tag to reconvene WiFi transmissions. The FSM will manage the process of cycling between states by maintaining Bluetooth LE communications whilst checking WiFi connectivity. During the period when the Reader Tag is unable to transmit data to the Cloud App, its FSM controls the transmission and storage of data on all Sensor Tags within the network. Auto-configuration of the functional states of tags within a network is a “smart” capability which is not present in other low-cost monitoring devices.

Network Topology

Another embodiment of this invention is its ability to self-manage the topology of a network to resolve network failures whilst other monitoring devices rely on manual means. In alternative systems, sensors which do not reliably communicate with a reader or gateway are typically re-positioned so as to bring them into range of the gateway. This is a trial and error process, which in the end, usually requires sensors to be positioned sub-optimally or to introduce additional costly repeaters or gateways into the network.

The alternative approach, which is an embodiment of this invention, involves a Reader Tag continuously monitoring the Received Signal Strength Indication (RSSI) of each Sensor Tag within the network. When the RSSI of a Sensor Tag falls or is lost, the FSM auto-configures all Sensor Tags in the network to RF Transceiver Mode so as to create a network topology in which each Sensor Tag cooperates in the distribution of data throughout the network (“mesh network”). The Reader Tag constructs a real-time RSSI Network Map to evaluate the optimal configuration of individual Sensor Tags within the network based on alternative RF pathways. It then returns specific Sensor Tags back to RF Transmission Mode (to conserve battery power) whilst leaving other Sensor Tags in RF Transceiver Mode. Optimal network performance is thereby achieved automatically.

Power Management

As for any other self-powered monitoring device, battery power management is critical to the effective deployment of the Smart Tag. Even though it has a rechargeable lithium polymer battery, any necessity to regularly re-charge the battery detracts from one of the main objectives of this invention, which is to require minimal user input. Consequently, the FSM continually seeks to minimise power consumption whilst maximising data communication by controlling the functional state of tags and networks.

An embodiment of the invention is the combined PCB design, component selection and firmware design which maximises Smart Tag battery life. In combination these elements ensure the tag spends more than 99.99% of the time ‘asleep’ (i.e. not capturing or transmitting data) under normal operating conditions. But even whilst it is ‘asleep’ some components must still consume power, including the micro-controller, RTC, reed switch and regulator. So the Smart Tag design ensures that the power draw on the battery in this state is less than 0.08 mAmps. Each time the tag captures and transmits data, it does so in less than 200 milliseconds and draws less than 6.0 mAmps. These capabilities ensure useful life of more than two years without the need to re-charge or replace the batteries.

Beyond design, firmware plays a key role in managing on-going communications and power consumption. When a tag is configured as a Reader Tag in WiFi mode and an external power source is lost or not available (to power the WiFi Module) the FSM configures the tag into a low power mode. The WiFi module is switched to ‘sleep mode’ and only deployed for a maximum of a few seconds every 30 minutes or so, during which time the module connects locally, opens the Internet connection, transmits the Data Packets and closes. Managing the WiFi transmissions in this way dramatically reduces battery power consumption.

Another example of managing battery power consumption of a Reader Tag, involves configuring the tag to remain in ‘listening’ mode for a defined period (e.g. 24 hours) during which time the FSM monitors and records the reporting frequency of individual Sensor Tags in the network. Since all tags have an accurate RTC, the precise time of data capture and reporting is known. Based on this information, the Reader Tag creates a schedule to listen for RF transmissions. The schedule may involve listening for RF transmissions on only a few occasions during each hour. Managing the RF Transceiver activity in this way dramatically reduces battery power consumption.

### User Configurations

The functional state of a Smart Tag is typically auto-configured and most system parameters are default set. For example the data capture and transmission rates are default-set but may be changed by the User to meet the specific needs of the application. However there are other system parameters that must be configured by the User since they are specific to the User's application. This includes parameters such as user settings (user names, passwords, permissions and roles), alert settings (upper and lower limits, notification delays), asset settings (assignment of asset names and tag ID's) and the like.

### Description of Functional States

The many functional states of a Smart Tag are described below with reference to attached figures. Most states (or Modes) are configured autonomously by the FSM and associated firmware, whilst others may be controlled by the User. User configuration may be achieved by depressing the tag button (in a defined sequence) or configuration via the Mobile App or Cloud App (see FIGS. 3a to 3j).

Mode 1—Sensor (RF Star) Mode is the standard default tag state. When a Sensor Tag is in RF Star Mode it captures data from its sensors, interprets, stores and subsequently transmits this data via RF to Reader Tag. When all Sensor Tags in a network function only as data transmitters, then the network is described as a star network. FIG. 3a shows four Sensor Tags (numbered 1 to 4) transmitting Tag Data to a Reader Tag. If all Sensor Tags are reliably communicating with the Reader Tag, the Reader Tag FSM maintains this state.

Mode 2—Sensor (RF Mesh) Mode is auto configured by a Reader Tag. When a Sensor Tag is in RF Mesh Mode it functions as a transceiver by capturing data from its sensors, receiving tag ID's and tag data from other Sensor Tags via RF, interpreting, storing and subsequently transmitting aggregated Tag Data via RF to a Reader Tag. If the Reader Tag is unable to communicate with any Sensor Tag within a network, the Reader Tag FSM auto-configures all Sensor Tags to function in mesh mode. As described previously (Network Topology) the Reader Tag creates a Tag Network Map and determines which tags should function in star mode and which tags should function in mesh mode. FIG. 3b shows Sensor Tag 3 transmitting Tag Data to Sensor Tag 2 in mesh (transceiver) mode and in turn transmitting aggregated Tag Data to the Reader Tag. This arrangement is auto-configured by the Reader Tag FSM to optimise data delivery whilst minimising battery power consumption.

Mode 3—Sensor (Transitional BLE) Mode is configured by the User pressing the tag button (in a defined sequence). When a Sensor Tag is in Transitional BLE Mode it captures data from its sensors, interprets, stores and subsequently transmits its tag data via BLE to a Smart Device running the Mobile App. FIG. 3c shows a Smart Device connected to a single Sensor Tag. BLE pairing (between the sensor tag and the Smart Device) is established by the FSM when the User presses the tag button (in a defined sequence). When the Mobile App is terminated the BLE connection, the Sensor Tag is re-configured to its default Sensor RF Star Mode.

Mode 4—Sensor (Static BLE) Mode is User configured to enable BLE communications between one or many Sensor Tags and a single Smart Device running the Mobile App. When a Sensor Tag is in this functional state, it captures data from its sensors, interprets, stores and subsequently transmits its Tag Data via BLE for receipt by a Smart Device running the CCP Smart App. FIG. 3d shows a Smart Device communicating with several Sensor Tags.

Mode 5—Sensor (WiFi) Mode is auto-configured by the FSM when a WiFi plug-in is connected. Initially, the tag is auto-configured in Reader (WiFi) Mode, but if no sensor data is received for a given period, the tag auto-configured as a Sensor Tag in WiFi Mode. When a Sensor Tag is in this state, it captures data from its sensors, interprets, stores and subsequently transmits its Tag Data via WiFi to the Cloud App. This embodiment of the invention is shown in FIG. 1e.

Mode 6—Reader (WiFi) Mode is auto-configured by the FSM when a WiFi plug-in is connected. In this mode the tag functions as a transceiver receiving data from Sensor Tags via RF, interpreting, aggregating, storing and subsequently transmitting this data via WiFi to the Cloud App. FIG. 3f shows the RF and WiFi connections. The Cloud App enables the User to access monitoring information derived from all Sensor Tags in the network, and to manually configure and write to individual Sensor Tags. The FSM (which continuously monitors tag performance) will auto-configure the Reader Tag to BLE Mode if the connection to the Cloud App is compromised in any way (e.g. WiFi router connection is lost). If the WiFi plug-in is removed, the tag auto-configures back to the default Sensor RF Star Mode.

Mode 7—Reader (USB) Mode is auto-configured by the FSM when a USB cable is connected to a tag. The tag then functions as a Reader Tag in transceiver mode receiving Tag Data via RF, interpreting, aggregating, storing and subsequently transmitting this data via the USB connected PC, laptop or other device to the Cloud App. This architecture is the same as for the Reader (WiFi) Mode except in this case a PC or similar is physically connected to the tag via a USB cable (see FIG. 3g). The FSM auto-configures the tag to Reader (BLE) Mode if the connection to the Cloud App is compromised in any way (e.g. PC internet connection is lost). If the USB cable is removed, the tag auto-configures back to the default Sensor RF Star Mode.

Mode 8—Reader (BLE) Mode requires User configuration. When so configured, the tag functions as a transceiver receiving Tag Data via RF, interpreting, aggregating, storing and then transmitting this data via BLE to a Smart Device running the Mobile App. FIG. 3h shows a Reader Tag connected to a Smart Device via BLE which in turn transmits Tag Data to the Cloud App via its Internet connection.

Mode 9—Shipment Mode requires User configuration. In this mode the tag captures data from its sensors, interprets, stores and transmits Tag Data via RF and BLE on a cyclical basis (see FIG. 3i). Since a tag in Shipment Mode is expected to be out of range of another connected device for undefinable periods, communications are continuously monitored by the FSM to minimise power consumption whilst optimising the prospect of communication. It achieves this by routinely cycling between communication methods. As shown in FIG. 3i, if Tag Data is received by a Reader Tag (via RF), the data may be transmitted to the Cloud App via a router, PC or a Smart Device. Alternatively, a Smart Device may receive the Tag Data directly and forward it to the Cloud App.

Mode 10—Shipment (RF Mesh) Mode requires User configuration. In this mode the tag functions the same way as it does in Shipment Mode, however it also transmits its ID and receives the ID of other Shipment Tags to create an ID reporting log. This log provides a record of all associated Shipment Tags. Based on the presence (or absence) of specific tag ID's, the security of a shipment can be confirmed. It may also provide protection from exposure to partial or complete counterfeit replacement (see FIG. 3j).

Mode 11—Firmware Update Mode may be auto-configured or manually configured. This mode enables a tag to receive and implement an alternative (usually later) version of firmware ‘over-the-air’ without the need for User intervention. Typically, all tags in a network will be automatically updated when new firmware becomes available through the Cloud App. When a Reader Tag communicates with the Cloud App Listener it is auto-configured to Firmware Update Mode. The tag is redirected to an alternative URL where the new firmware is received into Flash Memory and the tag updates to the new version firmware. If the firmware update is successful, the tag returns to its previous mode. However, if a problem with the new firmware is uncounted, the previous version of firmware is immediately restored and tag returns to its previous mode. When the Reader Tag resumes RF communications with Sensor Tags in the network, it sequentially auto-configures Sensor Tags to Firmware Update Mode and transmits a copy of the new version firmware into their Flash Memory via RF. The update process is then the same for each Sensor Tag as it is for the Reader Tag. By maintaining a copy of the old version firmware and enabling the firmware to restore is a critical step in the update process.

Smart Tag firmware may also be manually updated. This may be done by connecting the tag to a PC via a USB cable and pressing the tag button (in a defined sequence). Alternatively, the tag may be updated through a Smart Device running the Mobile App. In this case, BLE can be used to update the new version firmware.

Mode 12—Configuration Update Mode may be auto-configured or manually configured. This mode enables specific Sensor Tags to receive and implement new User configurations. New configurations may be created by a User either through the Cloud App or the Mobile App. If created in the Cloud App, the business layer identifies the Reader Tag through which the target Sensor Tag is communicating. Using the same process deployed in the firmware update mode, a tag configuration file is uploaded and updated. If the new configuration is created in the Mobile App, the configuration file is transmitted to the target Sensor Tag when it is in either Sensor (Transitional BLE) Mode or Sensor (Static BLE) Mode.

### Applications of the Invention

It is envisaged that the system will be deployed for many different applications across a diversity of industries. In the case of the food industry, where temperature control and monitoring of products and the environments in which they are held is critical, this invention has two particular applications. The first is for monitoring the environments in which products are held for extended periods such as in cool stores, freezers and merchandising cabinets at processing facilities, distribution centres and retail stores (known as In Store Monitoring), and the second is for monitoring products as they pass along the supply chain from production to retail at the carton or pallet level (known as Shipment Monitoring).

### In Store Monitoring

A typical application of the invention involves creating a wireless network of two or more (up to many hundreds of) Smart Tags each monitoring a specific assets within a facility. In Store Monitoring is a common application for distribution centres, cold storage facilities, retail stores and convenience stores since a wireless communication network provides the best means of collecting and managing data sourced from multiple points within a facility. The use of RF communications enables Smart Tags to transmit Tag Data over greater distances at a lower power consumption compared to either BLE or WiFi. The deployment of multiple Sensor Tags (in RF Transmission Mode) and one or more Reader Tags which are configured to communicate in RF with Sensor Tags and in BLE or WiFi with a Smart Device provides an optimal “In Store” monitoring solution. This approach eliminates any ‘monitoring system’ data cost because it creates and utilises a free RF network and exploits an existing Internet connection at no additional cost to the User.

Sensor Tags communicate either with Reader Tags or directly to a Smart Device. Typically, Tag Data is transmitted to a Reader Tag with a BLE or WiFi connection to a Smart Device which in turn transmits data to the Cloud App. Alternatively, a Sensor Tag may pair directly with a Smart Device via BLE to capture current data which may be viewed on the Smart Device or to transmit an alternative configuration or new firmware to the tag. The option of directly interfacing a Smart Device with a Sensor Tag enables local access to Tag Data should the User's Internet connection fail.

FIG. 4 shows a Smart Tag in ‘sensor’ mode which is default configured to detect temperature data from its internal temperature sensor. If an external sensor, probe or monitor is connected to a Sensor Tag, it automatically self-configures to ‘external sensor’ mode in order to detect data captured by the external sensor. A Sensor Tag may also detect an “open” or “closed” event from its internal reed switch when a magnet field is applied or removed by a magnet (3). This enables the Sensor Tag to detect the state of a door or other barrier that may open or close to affect the security or condition of an environmentally controlled environment. A Sensor Tag detects, stores and manages environmental data for transmission to either a Smart Device (4) via BLE or another tag in “reader” mode (5) via RF. A Smart Tag is automatically self-configured to “reader” mode when a Smart Device such as a WiFi Module or PC is connected to the tag. The Internet connected Smart Device in turn provides a connection for the transmission of data to the Cloud-based Service.

### Shipment Monitoring

Another application of the invention involves configuring a Smart Tag as a Shipment Tag (this functionality is previously described). The Shipment Tag is turned on, configured and placed within a carton or pallet load of product at the point of dispatch. The tag captures data at the configured interval and stores the records in memory. At a configured interval, the tag transmits a Data Packet or a Heart-beat Packet via RF and BLE. If an ACK is received from a Smart Device with an appropriate “security key” for the shipment, the tag assembles and transmits a Batch Data Packet which includes all data records since the tag was switched on (i.e. commencement of the shipment). If an ACK is not received, the tag continues to record and store data.

A Smart Device (with security permission) can be used to download data from a Shipment Tag using BLE. The invention provides user access to the monitoring data at any point along the supply chain. Since the data may also be automatically transmitted from the Smart Device via its Internet connection to the Cloud App, monitoring data relating to specific shipments can be viewed locally or from anywhere in the world at any time. Monitoring data may be passed to the Shelf-life Prediction Service at points along a supply chain to enable shelf-life predictions during transit.

The ability to use a Smart Device to capture shipment monitoring data at any point along a supply chain overcomes the limitation of other commercial devices deployed as “data-loggers” which require specialised equipment to download stored data. In many cases, data is only available from the data-logger once returned to its owner, precluding the opportunity to evaluate performance pro-actively at points along a supply chain or immediately upon arrival.

The invention also enables information regarding the shipment to be entered into the Smart Tag's flash memory so that the tag FSM can make decisions based on the specific characteristics of the shipment. For example, if the shipment is a carton of strawberries, the associated Smart Tag can automatically manage the set point and thresholds specific to strawberries. This reduces User work-load and ensures that the monitoring tolerances for the shipment are correctly set and performance can be correctly validated.

Mobile Application

An embodiment of the invention is a software application which may be installed and run on any Smart Device to enable local two-way communications with a Smart Tag (“Mobile App”). The Mobile App is designed and developed to suit most common types of operating systems used on Smart Devices (including Android, IOS and Windows). Communications between a Smart Device and a Smart Tag may be via either BLE or WiFi depending upon the hardware capabilities. In a typical application of the invention, communications are via BLE. This is a universal form of communication on Smart Devices today.

When the Mobile App is running on a Smart Device it may be ‘bonded’ with a Smart Tag either manually or automatically to enable BLE communications. If a Smart Tag is not in a functional state which regularly seeks to bond with a Smart Device, the User can press the Tag Button in a defined sequence to activate Transitional BLE mode. The Smart Tag may also be configured to function in Static BLE Mode, whereby connections and communications are automatically sequenced at a configurable interval (e.g. once per hour) to enable regular communications with a Smart Device. Once connected, the Smart App enables the User to retrieve and view current Tag Data (such as temperature, battery condition, door status and any other parameter) and to upload new versions of firmware and configurations to a Smart Tag. Access and permissions are controlled by a ‘software key’.

Since BLE communications consume significantly more battery power compared to RF communications, the Smart Tag FSM constantly monitors and manages the BLE connection. If BLE communications are inactive for a defined (configurable) period, the session is automatically closed and the radio reverts to RF communication mode. For example, when a new version of firmware is uploaded from a Smart Device to a tag, the BLE session is immediately closed as soon as the firmware file is received.

The Mobile App also enables a Smart Device to function as a ‘reader’, regularly capturing Tag Data from multiple (appropriately configured) Smart Tags and transmitting this data to the Cloud App via its WiFi connection. This approach eliminates the need for a Reader Tag. However, a network of Smart Tags communicating with a Smart Device in BLE at the same reporting frequency as RF will consume substantially more power. Therefore in this configuration, the Smart Tag reporting frequency is typically reduced (to say once every hour) to avoid the need for regular Smart Tag battery re-charging.

The deployment of Smart Devices, which is made possible through the Mobile App, substantially reduces the cost of this invention compared to alternative monitoring systems. It eliminates the need for expensive gateways with Internet connectivity (such as LAN or Cellular network engines) and any associated data plans. In this invention, Smart Devices provide several pathways for capturing monitoring data from sensors at no additional cost to the User. This advantage may be further extended through integration with other services, such as electronic (paperless) food safety records.

As shown in FIG. 5, the Mobile App incorporates the following major elements:
1. The Login Service (1) enables a Smart Tag and a Smart Device to bond via BLE, checks the security credentials of the User, and manages the connection to ensure reliable communications.
2. The Configuration Service (2) enables assets, users and alerts to be configured and presented to the Tag Communication Service for transmission to connected Smart Tag(s). It also manages WiFi configurations to enable the Smart Device to utilise its internal WiFi radio to connect to the Internet and communicate with the Cloud App. (Tag Data transmission is managed by the Tag Data Upload Service.)
3. The Tag Communication Service (3) enables the User to “Get Data” (such as current alerts, current temperature, battery condition, door status and any other parameter data), update new configurations (which may be set-up within the Configuration Service), and update new firmware (which is made available through the Cloud App).
4. The Smart Device database is deployed to store data in readiness for the Tag Data Upload Service to automatically “push” data to the Cloud App.
5. The Tag Data Upload Service (4) automatically monitors and manages the Smart Device WiFi connection and the transmission of Tag Data across this connection to the CCP Cloud App (based on a configurable IP Address) where it is interpreted, managed and stored.
6. The Dashboard (5) provides User access to the Status Screen (which displays all current Tag Data captured by the “Get Data” command in graphic and tabular format), an alerting module and a reporting engine, both of which may function independently of the Cloud App. This enables a User to access critical monitoring data whether or not an Internet connection is available. User access to real-time rather than historical monitoring data locally and via the Internet (Cloud) is a significant embodiment of this invention.

### Cloud Application

Another embodiment of the invention is a Cloud-based application which receives, interprets, stores and manages data from Smart Tags, analyses and evaluates data, manages Smart Tag functionality and performance through configurations and firmware, and provides secure 24 by 7 User access to a range of monitoring information and services.

As shown in FIG. 6, the Cloud App incorporates the following major elements:
1. The Login Service (1) is the User point of entry through the Internet whereby a user name and password is entered, security credentials are checked, and access is provided to the Application Services.
2. The Listener (2) is the point of entry for incoming Data Packets. Data Packets are validated by a CRC (Cyclic Redundancy Check), acknowledged and decrypted by the Listener before being stored in the fully-partitioned Cloud Database. If the Update Service has a new firmware or configuration file intended for one or many Smart Tags, the Listener will initiate the update process by advising the target tag of a pending update file.
3. The Update Service communicates new configurations and firmware versions to Smart Tags via the Listener. When a new firmware or configuration file is ready, the Update Service advises the Listener, which in turn advises the Smart Tag (as part of the ACK) of the pending file and the address for transfer. The Smart Tag then points to the new address and uploads the file. If the configuration or firmware file is for a Sensor Tag which does not directly communicate with the Cloud App, the system automatically identifies the associated Reader Tag through which its data is being communicated. The Reader Tag is then configured to act as a courier, receiving the file from the Cloud App (via the Internet) and then transferring it to the specific Sensor Tag during normal RF communications. The ability of the system to identify pathways to update specific Smart Tags whether or not they are reporting directly to the Cloud App is an embodiment of this invention.
4. Cloud Services include the Packet Processor, Notifications, Reporting, Corrective Actions, and a number of Business Intelligence Services which are tailored to the User's application.
5. The Packet Processor is responsible for interpreting Tag Data and converting it into usable information which can be displayed through the User Interface.
6. Notification Services, which are organised through the Configuration Manager, provide an automated messaging response to an alert event. Using various methods such as email, SMS message, push notifications and dashboard pup-ups, specified Users are notified of an alert or change in alert status and thereby provided the opportunity to take corrective actions to address the ‘failure’. An example of a notification is an email advising a User that “Door of Cool Room #3 is out of tolerance; being open for a period of longer than 30 minutes”.
7. Reporting Services, which are configured through the Configuration Manager, automatically generate reports in the form of tables and graphs. They are forwarded to the User for viewing and may be printed as required. As an example, the Reporting Service may be required to automatically generate a monthly temperature alert report in Excel tabular format at 06:00 on the 1^{st} day of the following month for defined parameters and forward this report to a specific User by email.
8. Corrective Actions are a specific compliance requirement for food safety records whereby the User is required to document actions taken to correct any out of tolerance events. In this system, corrective actions are associated with specific events as well as the type of the alert. This enables the Service to advise a User of alternative corrective actions that may be appropriately applied when a similar alert event re-occurs. When reports relating to food safety events are generated, associated corrective actions may also be included. This is an example of the interpretive capability of the invention.
9. Business Intelligence Services are industry specific services (information flows) which typically require complex data analysis or the use of predictive models. For the perishable food industry, Business Intelligence Services include Shelf-life Prediction, First-to-Expire-First-Out (FEFO) Selection, and Energy Efficiency Optimisation. These services are discussed in detail in the following sections.
10. The Configuration Manager (5) is an important component of the system since it aligns functionality and information flows with specific applications. Through the User Interface, a User (with the appropriate access which is determined by the User's role) may change the settings, parameters and functionality of the system in respect of Users, Alerts, Assets, Business Rules, Dashboard (presentation), Reports, Schedules and Business Intelligence Services. As previously described, changes to current configurations are managed and implemented through the Update Service and Listener.
11. Administration Services (6) include Support and Help Desk to provide Users with online assistance in the form of videos and documentation. Corporate administrative functions are integrated through an enterprise resource planning (ERP) system which forms part of the software system. This supports effective and efficient management of linked business activities including inventory, purchasing and sales.
12. The Dashboard (7) is the key element of the User Interface since it displays real-time and historical data in accordance with the Users requirements. Real-time data is managed asynchronously to ensure that the User has uninterrupted access to real time or near real-time data. The Dashboard presents information generated by the Cloud Services (including the Notifications Service, Reporting Service, Corrective Actions Service and Business Intelligence Services) in a visually appealing tabular and graphical format. An important embodiment of the invention is the hierarchical presentation of data and other information. For example, information which is most critical is always displayed most prominently. Information is also displayed in a summarised format with options to ‘drill-down’ to increasingly detailed levels depending upon a User requirement.
13. Web Services (8) enable data to flow into and out of the Cloud App. Web Services are a secure point of entry for data provided by third party applications, services and devices. Once data is processed through the Web Service, it is stored in the fully-partitioned Cloud Database. Web Services also enable the transmission of selected Tag Data to third party applications or services. They provide a simple yet robust means of integration with other systems. For example, the Shelf-life Prediction Service utilises Web Services to send temperature data to a third party Shelf-life Prediction Model. Upon completion of the analysis, this third party service returns the results through the Web Service.

### Business Intelligence Services

Business Intelligence Services include a collection of applications, algorithms, models and other functions which analyse and interpret monitoring data to create business intelligence. The system aims to provide Users with enhanced supply chain management information which can be used to maximise food shelf-life, quality and safety.

### Shelf-Life Prediction Service

The Shelf-life Prediction Service (“Shelf-life Service”) is a valuable tool which is most effectively utilised within a supply chain (particularly for goods in transit) when real-time data is available. Generally, historical shelf-life information does not provide the opportunity for a practical (in field) response to unfavourable shelf-life predictions.

In this invention, customised shelf-life prediction models (Shelf-life Models) are services (one or many) which are separate to the Cloud App. This provides an agnostic integration environment which is connected through Web Services. The ability and potential for separate or disperse services to be integrated through a Web Service is well understood. Where shelf-life prediction models are deployed in this way, their commercial function is de-coupled from Cloud App.

Shelf-life Models incorporate a database in which ‘observation data’ specific to one or more product types is stored. The database is accessed by the model to calculate shelf-life predictions based on a specified set of starting quality characteristics and dynamic product temperature data which is supplied through the Web Service from time to time. Observation data predicts the time remaining before the shelf-life of a specific quality characteristic expires (i.e. equals zero days) based on cumulative exposed temperature profiles.

The Shelf-life Service (as shown in FIG. 7) is described as follows:
1. Starting quality scores for each product characteristic (‘product quality data’) are assessed by skilled quality control (QA) inspectors when a product is being prepared for distribution through a supply chain. Examples of product quality characteristics may include colour, brix, decay, firmness and the like. Typically, this data is collected as a matter of normal business practice.
2. Product quality data is entered into the Shelf-life Service either manually through the Mobile or Cloud User Interface or through the Web Service (automatically).
3. A Smart Tag is assigned to the product and shipment, and shipment data is entered via the Mobile App or Cloud App and stored on the tag. The tag is activated as a Shipment Tag and begins capturing and reporting temperature data at the configured intervals.
4. When product quality data is entered into the system, the Shelf-life Service creates a new shipment. From that point on, Tag Data received through the Listener is entered into the Database and forwarded to the Shelf-life Service. The shipment data is then aggregated and passed through the Web Service to the Shelf-life Model.
5. The Shelf-life Model makes a determination of the predicted remaining shelf-life of the shipment for each quality characteristic and returns this prediction (in hours remaining before expiration) together with a “batch coefficient”. The batch coefficient defines the relative cumulative positioning of the determination along the shelf-life prediction curve. It must be returned with the next batch of data to enable the model to run from that defined point forward.
6. The remaining shelf-life is then made available to the User through the User Interface Dashboard, as well as the Notification Service and Reporting Service subject to the User Settings. Once the shipment is completed and all of the remaining shelf-life data has been determined for a shipment, a graphical representation of the shipment data (called a shelf-life curve) can be generated by the User for viewing through the Dashboard. FIGS. 8a and 8b are examples of shelf-life curves generated from actual temperature and remaining shelf-life data for different pallets of strawberries within a shipment ‘batch’ in transit across the US. Both figures clearly demonstrate the decline in shelf-life over time, as shown by the light blue line. The dark blue line shows the average temperature for the shipment batch. A comparison of figures demonstrates the dramatic difference in the remaining shelf-life profile for a pallet held at optimal temperatures (FIG. 8a) compared to a pallet which has been subjected to temperature abuse (FIG. 8b). The pallet shown in FIG. 8b has no remaining shelf-life (i.e. it expired on 10 October at 04:14). As the Shelf-life Service is a near real-time service, each of the associated services are automatically monitored by the system. If the performance of any service deteriorates, an alert it raised and the system administrator is notified.

In this invention, dynamic shelf-life predictions contrast with those from alternative systems. Rather than relying on generic predictions based on use of the Arrhenius equation, this invention passes real-time data to customised models which return shelf-life predictions for each quality characteristic based on empirical data collected for specific product types. When tested, equation-based shelf-life prediction engines have been found to be accurate for some products but highly inaccurate for others.

Knowledge of real-time shelf-life prediction data is a valuable supply chain management tool. It supports preventative food safety processes such as Hazard Analysis and Critical Control Point (HACCP) by providing an objective measure of the overall performance of a supply chain and relative performance at specific points along the chain. It provides food retailers with the opportunity to apply differential pricing to ‘clear’ products with a short remaining shelf-life before they expire. Products with a long remaining shelf-life can be priced at a premium. It can also be deployed to enable improved decision-making in respect of the distribution of products and shipments (both temporally and spatially) based on their actual rather than presumed shelf-life expiry. This invention envisages the use of shelf-life prediction data to enable a First-to-Expire-First-Out (FEFO) distribution management approach, rather than the traditional First-In-First-Out (FIFO) approach.

### First-to-Expire-First-Out (FEFO) Selection Service

FEFO decision-making at appropriate points along a food supply chain (such as at a distribution warehouse) can greatly enhance supply chain performance in terms of reduced food wastage and food safety risk. When perishable products are dispatched from a processing/packaging facility, a ‘use by’ or ‘best before’ date is usually assigned and attached either to the product (if packaging permits) or to the shipment paperwork. ‘Use by’ and ‘best before’ dates (“forecast expiry dates”) are based on a standard shelf-life curve which assumes the product is subject to ideal environmental conditions from the point of dispatch onwards. For example, when held under ideal conditions of 2° C. to 4° C., fresh strawberries have a maximum shelf-life of about 14 days. Consequently, a shipment of strawberries dispatched from a processing facility on 1 July will be typically assigned a forecast expiry date of 14 July. However, if this shipment of strawberries is transported to another site where it is subjected to an ambient temperature of +20° C. for a period of 24 hours, the remaining shelf-life of the product decline more rapidly than forecast and thereby cause the expiry date to be erroneous. It is well known by those experienced in the art that forecast expiry dates can be highly misleading and that reliance on erroneous dates for decisions regarding the distribution of products frequently results in food being wasted. Access to accurate and dynamic shelf-life prediction overcomes this substantial industry-wide problem.

The FEFO Selection Service provides a tabular output that can be used to manage the distribution of products through the supply chain (see table 1).

TABLE 1
FEFO Prediction Report (for shipping today)
From: 01-June-2014
To: 06-June-2014
Company: Pasco Berry Farms

| | Shipment Time/Date | | RSL | Dispatch |
|---|---|---|---|---|
| Shipment ID | Departure | Into Store | (Days) | TO (Store) |
| CN0021468 | 1/06/2014 13:00 | 5/06/2014 13:00 | 3.5 | Furley Store |
| CN0021469 | 1/06/2014 13:00 | 5/06/2014 13:00 | 3.5 | Furley Store |
| CN0021470 | 1/06/2014 13:00 | 5/06/2014 13:00 | 3.5 | Dunsborough Store |
| CN0021471 | 1/06/2014 13:00 | 5/06/2014 13:00 | 3.5 | Dunsborough Store |
| CN0021472 | 1/06/2014 13:00 | 5/06/2014 13:00 | 3.5 | Dunsborough Store |
| CN0021473 | 1/06/2014 21:00 | 5/06/2014 23:00 | 4.0 | Southmead Store |
| CN0021474 | 1/06/2014 21:00 | 5/06/2014 23:00 | 4.0 | Southmead Store |
| CN0021475 | 1/06/2014 21:00 | 5/06/2014 23:00 | 4.0 | Southmead Store |
| CN0021476 | 1/06/2014 21:00 | 5/06/2014 23:00 | 4.0 | Newstead Store |
| CN0021477 | 1/06/2014 21:00 | 5/06/2014 23:00 | 4.0 | Newstead Store |
| CN0021478 | 1/06/2014 21:00 | 5/06/2014 23:00 | 5.0 | Stanley Park Store |
| CN0021479 | 1/06/2014 21:00 | 5/06/2014 23:00 | 5.0 | Stanley Park Store |
| CN0021480 | 3/06/2014 14:45 | 6/06/2014 16:00 | 5.5 | Howlong Store |
| CN0021481 | 3/06/2014 14:45 | 6/06/2014 16:00 | 6.0 | Cantebury Store |
| CN0021482 | 3/06/2014 14:45 | 6/06/2014 16:00 | 5.5 | Howlong Store |
| CN0021483 | 3/06/2014 14:45 | 6/06/2014 16:00 | 5.0 | Stanley Park Store |

With access to accurate remaining shelf-life data associated with each pallet or carton (“unit”) of product, the User can distribute each pallet or carton of product in a way which enables the product to be best utilised. For example, a grocery store chain using this service at a distribution centre (DC) could determine which specific units of product should be delivered to which store based upon the actual product expiry date and the location and turn-over of each store. Units of product with a relatively short remaining shelf-life should be shipped to stores closest to the DC or with the highest turn-over. In contrast, units of product with a relatively long remaining shelf-life could be shipped to stores most distant from the DC or with the lowest turn-over. FEFO decision making can deliver substantial reductions in food wastage and “out of stock” occurrences for food retail and food service operators.

### Energy Efficiency Optimisation Service

The Energy Efficiency Optimisation Service continuously analyses real-time temperature and energy consumption data to determine the optimal refrigeration system setting to deliver the lowest rate of energy consumption (KW/hr) whilst maintaining the quality and safety of the food held within the system. This is a dynamic service which involves processing an iterative determination of the impact of changes in the refrigeration system set-point on product temperature. This information can be made available to the User through the Notification Service, Reporting Service and the Dashboard.

### Climate Control System Maintenance Service

The Climate Control System Maintenance Service functions as a ‘background ‘service, continuously analysing the real-time and historical temperature profiles of each climate controlled asset. By applying trend analysis techniques, time and temperature profiles (typically from defrost cycle to defrost cycle) are defined and compared. This reveals changes in the capacity of the system to maintain set point temperature. When a configurable trigger point or tolerance is reached, the service can be configured to create a performance alert and to generate a report of the underlying data which has led to the alert.

It is envisaged that this functionality of the invention creates considerable value to those involved in or responsible for the maintenance of climate control assets. By undertaking continuous detailed analysis, the service can alert technicians to a likely system failure before it occurs. This may provide the opportunity to repair the system before a failure and consequential loss of product occurs.

Those skilled in the art will appreciate that this invention may be implemented in embodiments other than those described without departing from the core teachings of the invention.

1. A programmed device that includes at least one sensor, a processor, a data store, a transmitter and receiver for wireless communication and, wherein the processor is programmed to operate the device as a data collector for data signals from the sensor in the device or from other sensors wirelessly connected to the device and when a computing device is wirelessly connected to the programmed device it acts as a data reader providing data to the external computing device.

2. The programmed device as claimed in claim 1 which additionally includes at least one data input port to enable connection to other sensors or other programmed devices and/or at least one output port and when a computing device is connected to said outlet port it acts as a data reader providing data to said external computing device.

3. The programmed device as claimed in claim 1 in which the processor incorporates a Finite State Machine (“FSM”) and associated firmware which automatically monitors, analyses and controls (auto-configures) the functional state of the programmed device.

4. A system including a programmed device as claimed in claim 1 and a computing device programmed to enable receiving, storing, interpreting, displaying and transmitting of data from said programmed device.

5. The system as claimed in claim 4 wherein wireless communication
between said programmed device and other programmed devices and communication with an external computing device is either by Wi-Fi, low energy blue tooth or radio frequency.

6. A network which includes two or more programmed devices as claimed in claim 1 in which one of said programmed devices is in reader mode and the others are in sensor mode

7. The network as claimed in claim 6 which also includes an external computing device.

8. A method for managing the distribution and sale of perishable goods in which
data relating to the condition of the goods is entered and stored at the time of dispatch of said goods;
data relating to the environment of said goods during transport and storage is regularly collected and stored and periodically transmitted to a central processor;
the predicted shelf life of said goods is calculated by said central processor programmed to use the dispatch data and the transport and storage data to calculate an expected expiry date; and
an expected expiry date for the goods is assigned to said goods at the time when the goods are displayed for sale.

9. The method as claimed in claim 8 wherein the data collected during transport and storage is collected by one or more programmed devices that includes at least one sensor, a processor, a data store, a transmitter and receiver for wireless communication and, wherein the processor is programmed to operate the device as a data collector for data signals from the sensor in the device or from other sensors wirelessly connected to the device and when a computing device is wirelessly connected to the programmed device it acts as a data reader providing data to the external computing device in sensor mode.

10. The method as claimed in claim 8 wherein the collected data is read by a programmed device that includes at least one sensor, a processor, a data store, a transmitter and receiver for wireless communication and, wherein the processor is programmed to operate the device as a data collector for data signals from the sensor in the device or from other sensors wirelessly connected to the device and when a computing device is wirelessly connected to the programmed device it acts as a data reader providing data to the external computing device in reader mode and sent to the central processor.

11. The programmed device as claimed in claim 2 in which the processor incorporates a Finite State Machine (“FSM”) and associated firmware which automatically monitors, analyses and controls (auto-configures) the functional state of the programmed device.
